(19) United States
(12) Patent Application Publication
(10) Pub. No.: US 2007/0135010 A1
(43) Pub. Date: Jun. 14, 2007

(54) Polychloprene composite having adhesive with copolymer of polychloroprene and dichlorobutadiene

(75) Inventors: Judy Chu, Hudson, OH (US); James Gregory Gillick, Akron, OH (US)

Correspondence Address: John D. DeLong;The Goodyear Tire & Rubber Company, Intellectual Property Law Department D/823, 1144 East Market Street, Akron, OH, 44316-0001, US

(73) Assignee: The Goodyear Tire & Rubber Company

(21) Appl. No.: 11/705,022

(22) Filed: Feb. 12, 2007

Related U.S. Application Data
(63) Continuation of application No. 10/198,489, filed on Jul. 18, 2002, now abandoned.

(51) Int. Cl. B32B 25/10; B32B 27/12

(52) U.S. Cl. 442/394; 442/37; 442/398; 442/399; 428/147

(57) ABSTRACT

The present invention is directed to a composite material comprising a vulcanizable polychloroprene rubber composition and textile fibers, the fibers having distributed over surface portions thereof an adhesive comprising a resorcinol-formaldehyde resin and a copolymer of from about 1 weight percent to about 10 weight percent 2,3-dichloro-1,3-butadiene and from about 90 weight percent to about 99 weight percent chloroprene.

### FIELD OF THE INVENTION

The present invention is directed to a composite material comprising a vulcanizable polychloroprene rubber composition and textile fibers, the fibers having distributed over surface portions thereof an adhesive comprising a resorcinol-formaldehyde resin and a copolymer of from about 1 weight percent to about 10 weight percent 2,3-dichloro-1,3-butadiene and from about 90 weight percent to about 99 weight percent chloroprene.

### BACKGROUND OF THE INVENTION

In the manufacture of many fabric-reinforced, molded rubber articles, it is desirable to obtain strong adherence between the fabric and the rubber, and also high resistance to deterioration of the bond with flexing of the structure.

Many adhesives known to produce very strong bonds between rubber and fabric are entirely unsuitable for many rubber fabric structures because the bonds deteriorate or the fabric ruptures when the structures are subjected to repeated flexing at elevated temperatures. Thus, flex-life cannot be foretold from measurements of bond strengths alone.

Resorcinol-formaldehyde-latex (RFL) dips have been widely implemented for bonding synthetic fabrics to rubber. For instance, U.S. Pat. No. 3,525,703 discloses a water-based adhesive composition for bonding synthetic fiber material to rubber. The teachings of U.S. Pat. No. 3,525,703 specifically disclose the utilization of styrene-butadiene latex and vinylpyridine-styrene-butadiene latex in such water-based adhesive compositions.

One specific example of an industrial product that typically utilizes a composite material is an air sleeve. Air sleeves have a rubber innerliner, two plies of cord fabric, and a rubber cover. These sleeves see their greatest commercial usage in the automotive helper spring market by being mounted as air springs on shock absorbers and struts. Other uses include truck cab suspension springs, truck driver seat springs, automobile air springs, and a variety of industrial air springs.

The plies of cord fabric are contained within a reinforcement layer, which along with the cord fabric includes an elastomeric base made from a rubber compound. The reinforcement layer may be provided from a plurality of different types of materials. The rubber compound of the elastomeric base is selected from among elastomers conventionally used in manufacturing air sleeves, included, but not limited to elastomers such as polychloroprene, poly-epichlorohydrin, polyisobutylene, halogenated-polyisobutylene, natural rubber, polyisoprene, polybutadiene, styrene-butadiene, and blends of such elastomers. Also included in the rubber compound are various additives, including but not limited to acid acceptors such as magnesium oxide.

The adhesion of cord fabric to the elastomeric base is essential for acceptable performance of air sleeves. In particular, the adhesion of nylon cord to polychloroprene compound is essential for field performance, especially for its high stress tolerance. An adhesive based on a styrene-butadiene rubber (SBR) latex is often used to adhere nylon cord to a polychloroprene elastomeric base. However, air sleeves using SBR-based adhesive have shown poor adhesion between nylon cord and polychloroprene compound at high stress. An alternative adhesive is therefore desirable to improve adhesion in air sleeves.

Japanese Publication No. 59-089375 discloses an adhesive composition, consisting of a specific chloroprene-dichlorobutadiene copolymer latex and recorcinol formaldehyde resin, capable of bonding fibers treated at a high temperature for a long time effectively to chloroprene rubber. The copolymer is disclosed to have a weight ratio of chloroprene to dichlorobutadiene in a range of 80/20 to 20/80.

U.S. Pat. No. 5,306,369 discloses a process of bonding aromatic polyamide fibers to rubber compounds, comprises a two step application of fiber treatment, including a first step of treating fibers with an aqueous mixture comprising a resorcinol/formalin resin and a latex of a polymer containing halogens in amounts of not less than 45 percent by weight based on the polymer. It is disclosed therein that the polymer may include copolymers of dichlorobutadiene and chloroprene, but no specific compositions of such a copolymer are disclosed or exemplified.

U.S. Pat. No.5,626,953 discloses a power transmission belt, wherein the adhesion of polyester fibers to chlorosulfonated polyolefin rubber is enhanced by a two-step fiber treatment with an isocyanate followed by a mixture having at least resorcinol/formaldehyde resin and a dichlorobutadiene-containing polymer. There is no disclosure therein of the use of a chloroprene/dichlorobutadiene copolymer.

U.S. Pat. No. 5,332,771 discloses an adhesive composition consisting essentially of a copolymer of chloroprene and dichlorobutadiene, a rosin ester, and zinc oxide or magnesium oxide.

U.S. Pat. No. 5,691,415 discloses a reinforced plastic body which comprises a chlorosulfonated polyolefin reinforced with polyester fibers having an adhesive containing an isocyanate and/or epoxy and an adhesive composed of a mixture of a resorcinol/formaldehyde resin and a dichlorobutadiene-containing polymer. It is further therein disclosed that the dichlorobutadiene-containing polymer may include a copolymer of dichlorobutadiene and chloroprene, but that the dichlorobutadiene homopolymer is preferred. The use of a copolymer of 20 weight percent chloroprene and 80 weight percent dichlorobutadiene is exemplified therein.

U.S. Pat. No. 6,054,527 discloses a single adhesive composition for use in bonding rubber polymer to textiles, in particular nylon and polyester fabrics, wherein the adhesive comprising an aqueous mixture of a polychloroprene latex, a prepolymer of resorcinol and formaldehyde, a blocked diisocyanate, and water. It is not disclosed therein that the polychloroprene latex may include a dichlorobutadiene/chloroprene copolymer. Use of the polychloroprene latex as exemplified therein showed poor adhesion of nylon fabric to polychloroprene rubber.

### SUMMARY OF THE INVENTION

In one aspect, the present invention is directed to a composite material comprising a vulcanizable polychloroprene rubber composition and textile fibers, the fibers having distributed over surface portions thereof an adhesive comprising a resorcinol-formaldehyde resin and a copolymer of from about 1 weight percent to about 10 weight percent 2,3-dichloro-1,3-butadiene and from about 90 weight percent to about 99 weight percent chloroprene.

In another aspect, the present invention is directed to an article of manufacture comprising a composite material, wherein the composite material comprises a vulcanizable polychloroprene rubber composition and textile fibers, the fibers having distributed over surface portions thereof an adhesive comprising a resorcinol-formaldehyde resin and a copolymer of from about 1 weight percent to about 10 weight percent 2,3-dichloro-1,3-butadiene and from about 90 weight percent to about 99 weight percent chloroprene. The article of manufacture may be an air sleeve, pneumatic tire, automotive hose, or automotive belt.

In yet another aspect, the present invention is directed to a method a adhering textile fibers to a vulcanizable polychloroprene rubber compound in a composite material.

### DESCRIPTION OF THE INVENTION

In one embodiment, the present invention is directed to a composite material comprising a vulcanizable rubber composition and textile fibers, the fibers having distributed over surface portions thereof an adhesive comprising a resorcinol-formaldehyde resin and a copolymer of from about 1 weight percent to about 10 weight percent 2,3-dichloro-1,3-butadiene and from about 90 weight percent to about 99 weight percent chloroprene.

In another embodiment, the present invention is directed to an air sleeve having at least one reinforcement layer and a cover disposed adjacent to the reinforcement layer, with the reinforcement layer including an adhesive comprising polychloroprene and polydichlorobutadiene.

The composite material includes an adhesive comprising a resorcinol-formaldehyde resin and a copolymer of from about 1 weight percent to about 10 weight percent 2,3-dichloro-1,3-butadiene and from about 90 weight percent to about 99 weight percent chloroprene. Chloroprene is understood to include monochlorinated butadiene, such as 2-chloro-1,3-butadiene. Dichlorobutadiene is understood to include 2,3-dichloro-1,3-butadiene.

The adhesive is general used in the form of an aqueous latex. The latices are prepared by free radical emulsion polymerization of chloroprene and dichlorobutadiene to form a copolymer latex. The charge compositions used in the preparation of the latices contain monomers, at least one surfactant, and at least one free radical initiator. Such latices are well known and made be made by any of various methods as are known in the art. In one embodiment, the resulting copolymer contains from about 90 to about 99 percent by weight of chloroprene, and from about 1 to about 10 percent by weight of dichlorobutadiene. In another embodiment, the copolymer contains from about 95 to about 98 percent by weight of chloroprene, and from about 2 to about 5 percent by weight of dichlorobutadiene. Suitable latices may contain from about 40 to about 60 percent by weight total solids in water. A suitable chloroprene/dichlorobutadiene latex is commercially available as NEOPRENE®750 from DuPont Dow Elastomers.

The composite material includes an adhesive composition useful in adhering synthetic fibers to the vulcanizable rubber composition. The adhesive composition is comprised of (1) resorcinol, (2) formaldehyde and (3) the chloroprene/dichlorobutadiene copolymer latex. The resorcinol reacts with formaldehyde to produce a resorcinol-formaldehyde reaction product. This reaction product is the result of a condensation reaction between a phenol group on the resorcinol and the aldehyde group on the formaldehyde. Resorcinol resoles and resorcinol-phenol resoles, whether formed in situ within the latex or formed separately in aqueous solution, are considerably superior to other condensation products in the adhesive mixture.

The resorcinol may be dissolved in water to which around 37 percent formaldehyde has been added together with a strong base such as sodium hydroxide. The strong base should generally constitute around 7.5 percent or less of the resorcinol, and the molar ratio of the formaldehyde to resorcinol should be in a range of from about 1.5 to about 2. The aqueous solution of the resole or condensation product or resin is mixed with the chloroprene/dichlorobutadiene copolymer latex. The resole or other mentioned condensation product or materials that form said condensation product should constitute from 5 to 40 parts and preferably around 10 to 25 parts by solids of the latex mixture. The condensation product forming the resole or resole type resin forming materials should preferably be partially reacted or reacted so as to be only partially soluble in water. Sufficient water is then preferably added to give around 12 percent to 18 percent by weight overall solids in the final dip. The weight ratio of the polymeric solids from the latex (including the copolymer of chloroprene and dichlorobutadiene, and any second polymer) to the resorcinol/formaldehyde resin should be in a range of about 5 to about 7.

The RFL adhesive may optionally include a blocked isocyanate. In one embodiment from about 1 to about 20 parts by solid of blocked isocyanate is added to the adhesive. The blocked isocyanate may be any suitable blocked isocyanate known to be used in RFL adhesive dips, including but not limited to caprolactam blocked methylene-bis-(4-phenylisocyanate), such as Grilbond-IL6 available from EMS American Grilon, Inc., and phenol formaldehyde blocked isocyanates as disclosed in U.S. Pat. Nos. 3,226,276, 3,268,467; and 3,298,984, the three of which are fully incorporated herein by reference.

The RFL adhesive may further optionally include at least one second polymer added in the form of a latex or otherwise. In one embodiment, a vinylpyridine-styrene-butadiene terpolymer latex may be added to the RFL adhesive. The vinylpyridiene-styrene-butadiene terpolymer may be present in the RFL adhesive such that the solids weight of the vinylpyridiene-styrene-butadiene terpolymer is from about 50 percent to about 100 percent of the solids weight of the copolymer of chloroprene and dichlorobutadiene; in other words, the weight ratio of copolymer of chloroprene and 2,3-dichloro-1,3-butadiene to vinylpyridene-styrene-butadiene terpolymer is from about 1 to about 2.

It is normally preferable to first prepare the copolymer latex and then add the partially condensed condensation product. However, the ingredients (the resorcinol and formaldehyde) can be added to the latex in the uncondensed form and the entire condensation can then take place in situ. The latex tends to keep longer and be more stable if it is kept at an alkaline pH level.

In accordance with this invention, the cord or fabric to be treated is dipped for one to three minutes in the RFL dip and dried at a temperature within the range of about 75° C. to about 265° C. for about 0.5 minutes to about 20 minutes and thereafter calendered into the rubber and cured therewith. The drying step utilized will preferably be carried out by passing the cord through 2 or more drying ovens which are maintained at progressively higher temperatures. For instance, it is highly preferred to dry the cord by passing it through a first drying oven which is maintained at a temperature of about 250° F. (121° C.) to about 300° F. (149° C.) and then to pass it through a second oven which is maintained at a temperature which is within the range of about 350° F. (177° C.) to about 500° F. (260° F.). It should be appreciated that these temperatures are oven temperatures rather than the temperature of the cord being dried. The cord will preferably have a total residence time in the drying ovens which is within the range of about 1 minute to about 5 minutes. For example, a residence time of 30 seconds to 90 seconds in the first oven and 30 seconds to 90 seconds in the second oven could be employed.

The dip process may be carried out in one or two steps. For a one step process, the solids content of the dip may be adjusted to a higher level to achieve adequate coverage. For a two-step process, the solids content of the dip for the second step may be adjusted to approximately one-half to two-thirds of the solids content of the first step, to obtain the desired coverage. Adjustment of the solids content of the dips for a one or two-step dipping process is done as required, as is known to one skilled in the art.

Textile fibers in the form of suitable cord or fabric may be in various forms, including woven fabrics, knitted fabric, or spun bonded fabric, and fiber cord. The cord or fabric may be comprised of various materials typically used as reinforcement in composite materials, including rayon, nylon, polyester, aramid, cotton, and combinations thereof.

The composite material includes a vulcanizable rubber composition. One component of the vulcanizable rubber composition is at least one elastomer selected from among elastomers conventionally used in various articles of manufacture. Such elastomers include but are not limited to elastomers such as polychloroprene, poly-epichlorohydrin, polyisobutylene, halogenated-polyisobutylene, natural rubber, polyisoprene, polybutadiene, styrene-butadiene, and blends of such elastomers. In one embodiment, the vulcanizable rubber composition includes polychloroprene.

In addition to the elastomers in the vulcanizable rubber composition, fillers may be also present. The amount of such fillers may range from 10 to 250 phr. Preferably, the filler is present in an amount ranging from 20 to 100 phr.

The commonly employed siliceous pigments which may be used in the rubber compound include conventional pyrogenic and precipitated siliceous pigments (silica), although precipitated silicas are preferred. The conventional siliceous pigments preferably employed in this invention are precipitated silicas such as, for example, those obtained by the acidification of a soluble silicate, e.g., sodium silicate.

Such conventional silicas might be characterized, for example, by having a BET surface area, as measured using nitrogen gas, preferably in the range of about 40 to about 600, and more usually in a range of about 50 to about 300 square meters per gram. The BET method of measuring surface area is described in the Journal of the American Chemical Society, Volume 60, Page 304 (1930).

The conventional silica may also be typically characterized by having a dibutylphthalate (DBP) absorption value in a range of about 100 to about 400, and more usually about 150 to about 300.

The conventional silica might be expected to have an average ultimate particle size, for example, in the range of 0.01 to 0.05 micron as determined by the electron microscope, although the silica particles may be even smaller, or possibly larger, in size.

Various commercially available silicas may be used, such as, only for example herein, and without limitation, silicas commercially available from PPG Industries under the Hi-Sil trademark with designations 210, 243, etc; silicas available from Rhodia, with, for example, designations of Z1165MP and Z165GR and silicas available from Degussa AG with, for example, designations VN2 and VN3, etc.

Commonly employed carbon blacks can be used as a conventional filler. Representative examples of such carbon blacks include N110, N121, N220, N231, N234, N242, N293, N299, S315, N326, N330, M332, N339, N343, N347, N351, N358, N375, N539, N550, N582, N630, N642, N650, N683, N754, N762, N765, N774, N787, N907, N908, N990 and N991. These carbon blacks have iodine absorptions ranging from 9 to 145 g/kg and DBP No ranging from 34 to 150 cm³/100 g.

It may be preferred to have the vulcanizable rubber composition for use in the composite material to additionally contain a conventional sulfur containing organosilicon compound. Examples of suitable sulfur containing organosilicon compounds are of the formula:
Z-Alk-Sₙ-Alk-Z I
in which Z is selected from the group consisting of 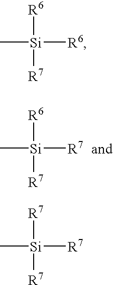
where R⁶ is an alkyl group of 1 to 4 carbon atoms, cyclohexyl or phenyl; R⁷ is alkoxy of 1 to 8 carbon atoms, or cycloalkoxy of 5 to 8 carbon atoms; Alk is a divalent hydrocarbon of 1 to 18 carbon atoms and n is an integer of 2 to 8.

Specific examples of sulfur containing organosilicon compounds which may be used in accordance with the present invention include: 3,3′-bis(trimethoxysilylpropyl) disulfide, 3,3′-bis(triethoysilylpropyl) disulfide, 3,3′bis(triethoxysilylpropyl) tetrasulfide, 3,3′-bis(triethoxysilylpropyl) octasulfide, 3,3′-bis(trimethoxysilylpropyl) tetrasulfide, 2,2′-bis(triethoxysilylethyl)tetrasulfide, 3,3′-bis(trimethoxysilylpropyl) trisulfide, 3,3′-bis(triethoxysilylpropyl)trisulfide, 3,3′-bis(tributoxysilylpropyl)disulfide, 3,3′-bis(trimethoxysilylpropyl)hexasulfide, 3,3′-bis(trimethoxysilylpropyl)octasulfide, 3,3′-bis(trioctoxysilylpropyl)tetrasulfide, 3,3′-bis(trihexoxysilylpropyl)disufide, 3,3′-bis(tri-2″-ethylhexoxysilylpropyl)trisulfide, 3,3′-bis(triisooctoxysilylpropyl) tetrasulfide, 3,3′-bis(tri-t-butoxysilylpropyl)disulfide, 2,2′-bis(methoxy diethoxy silyl ethyl)tetrasulfide, 2,2′-bis(tripropoxysilylethyl)pentasulfide, 3,3′-bis(tricyclonexoxysilylpropyl)tetrasulfide, 3,3′-bis(tricyclopentoxysilylpropyl) trisulfide, 2,2′-bis(tri-2″-methylcyclohexoxysilylethyl)tetrasulfide, bis(trimethoxysilylmethyl)tetrasulfide, 3-methoxy ethoxy propoxysilyl 3′-diethoxybutoxy-silylpropyltetrasulfide, 2,2′-bis(dimethyl methoxysilylethyl)disulfide, 2,2′-bis(dimethyl sec.butoxysilylethyl)trisulfide, 3,3′-bis(methyl butylethoxysilylpropyl) tetrasulfide, 3,3′-bis(di t-butylmethoxysilylpropyl)tetrasulfide, 2,2′-bis(phenyl methyl methoxysilylethyl)trisulfide, 3,3′-bis(diphenyl isopropoxysilylpropyl)tetrasulfide, 3,3′-bis(diphenyl cyclohexoxysilyipropyl)disulfide, 3,3-bis(dimethyl ethylmercaptosilylpropyl)tetrasulfide, 2,2′-bis(methyl dimethoxysilylethyl)trisulfide, 2,2′-bis(methyl ethoxypropoxysilylethyl)tetrasulfide, 3,3′-bis(diethyl methoxysilylpropyl)tetrasulfide, 3,3′-bis(ethyl di-sec.butoxysilyipropyl)disulfide, 3,3′-bis(propyl diethoxysilylpropyl)disulfide, 3,3′-bis(butyl dimethoxysilylpropyl) trisulfide, 3,3′-bis(phenyl dimethoxysilylpropyl)tetrasulfide, 3-phenyl ethoxybutoxysilyl 3′-trimethoxysilylpropyl tetrasulfide, 4,4′-bis(trimethoxysilylbutyl)tetrasulfide, 6,6′-bis(triethoxysilylhexyl)tetrasulfide, 12,12′-bis(triisopropoxysilyl dodecyl)disulfide, 18,18′-bis(trimethoxysilyloctadecyl)tetrasulfide, 18,1 8′-bis(tripropoxysilyloctadecenyl) tetrasulfide, 4,4′-bis(trimethoxysilyl-buten-2-yl)tetrasulfide, 4,4′-bis(trimethoxysilylcyclohexylene)tetrasulfide, 5,5′-bis(dimethoxymethylsilylpentyl) trisulfide, 3,3′-bis(trimethoxysilyl-2-methylpropyl)tetrasulfide, 3,3′-bis(dimethoxyphenylsilyl-2-methylpropyl)disulfide.

The preferred sulfur containing organosilicon compounds are the 3,3′-bis(trimethoxy or triethoxy silylpropyl)sulfides. The most preferred compounds are 3,3′-bis(triethoxysilylpropyl)disulfide and 3,3′-bis(triethoxysilylpropyl)tetrasulfide. Therefore as to formula I, preferably Z is 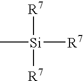
where R⁷ is an alkoxy of 2 to 4 carbon atoms, with 2 carbon atoms being particularly preferred; alk is a divalent hydrocarbon of 2 to 4 carbon atoms with 3 carbon atoms being particularly preferred; and n is an integer of from 2 to 5 with 2 and 4 being particularly preferred.

The amount of the sulfur containing organosilicon compound of formula I in a rubber composition will vary depending on the level of other additives that are used. Generally speaking, the amount of the compound of formula I will range from 0.5 to 20 phr. Preferably, the amount will range from 1 to 10 phr.

It is readily understood by those having skill in the art that the vulcanizable rubber composition would be compounded by methods generally known in the rubber compounding art, such as mixing the various sulfur-vulcanizable constituent rubbers with various commonly used additive materials such as, for example, sulfur donors, curing aids, such as activators and retarders and processing additives, such as oils, resins including tackifying resins and plasticizers, fillers, pigments, fatty acid, zinc oxide, waxes, antioxidants and antiozonants and peptizing agents. As known to those skilled in the art, depending on the intended use of the vulcanizable and vulcanized material (rubbers), the additives mentioned above are selected and commonly used in conventional amounts. Representative examples of sulfur donors include elemental sulfur (free sulfur), an amine disulfide, polymeric polysulfide and sulfur olefin adducts. Preferably, the sulfur vulcanizing agent is elemental sulfur. The sulfur vulcanizing agent may be used in an amount ranging from 0.5 to 8 phr. Typical amounts of tackifier resins, if used, comprise about 0.5 to about 10 phr, usually about 1 to about 5 phr. Typical amounts of processing aids comprise about 1 to about 50 phr. Such processing aids can include, for example, aromatic, naphthenic, and/or paraffinic processing oils. Typical amounts of antioxidants comprise about 1 to about 5 phr. Representative antioxidants may be, for example, diphenyl-p-phenylenediamine and others, such as, for example, those disclosed in the Vanderbilt Rubber Handbook (1978), Pages 344 through 346. Typical amounts of antiozonants comprise about 1 to 5 phr. Typical amounts of fatty acids, if used, which can include stearic acid comprise about 0.5 to about 3 phr. Typical amounts of zinc oxide comprise about 2 to about 10 phr. Typical amounts of waxes comprise about 1 to about 5 phr. Often microcrystalline waxes are used. Typical amounts of peptizers comprise about 0.1 to about 1 phr. Typical peptizers may be, for example, pentachlorothiophenol and dibenzamidodiphenyl disulfide.

Accelerators are used to control the time and/or temperature required for vulcanization and to improve the properties of the vulcanizate. In one embodiment, a single accelerator system may be used, i.e., primary accelerator. The primary accelerator(s) may be used in total amounts ranging from about 0.5 to about 4, preferably about 0.8 to about 1.5, phr. In another embodiment, combinations of a primary and a secondary accelerator might be used with the secondary accelerator being used in smaller amounts, such as from about 0.05 to about 3 phr, in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are amines, disulfides, guanidines, thioureas, thiazoles, thiurams, sulfenamides, dithiocarbamates and xanthates.

The mixing of the vulcanizable rubber composition can be accomplished by methods known to those having skill in the rubber mixing art. For example the ingredients are typically mixed in at least two stages, namely at least one non-productive stage followed by a productive mix stage. The final curatives including sulfur vulcanizing agents are typically mixed in the final stage which is conventionally called the “productive” mix stage in which the mixing typically occurs at a temperature, or ultimate temperature, lower than the mix temperature(s) than the preceding non-productive mix stage(s). The rubber and inversion carbon black are mixed in one or more non-productive mix stages. The terms “non-productive” and “productive” mix stages are well known to those having skill in the rubber mixing art. The inversion carbon black may be added as a separate ingredient or in the form of a masterbatch. The rubber composition containing the inversion carbon black and tin-amino functionalized rubber, as well as the sulfur-containing organosilicon compound, if used, may be subjected to a thermomechanical mixing step The thermomechanical mixing step generally comprises a mechanical working in a mixer or extruder for a period of time suitable in order to produce a rubber temperature between 140° C. and 190° C. The appropriate duration of the thermomechanical working varies as a function of the operating conditions and the volume and nature of the components. For example, the thermomechanical working may be from 1 to 20 minutes.

The composite material may be fabricated using any of various fabrication processes as are known in the art. In one embodiment, the composite material is included as at least one component of an air sleeve. Vulcanization of the air sleeve of the present invention is generally carried out at conventional temperatures ranging from about 100° C. to 200° C. Preferably, the vulcanization is conducted at temperatures ranging from about 110° C. to 180° C. Any of the usual vulcanization processes may be used such as heating in a press or mold, heating with superheated steam or hot air. Such air sleeves can be built, shaped, molded and cured by various methods which are known and will be readily apparent to those having skill in such art. In one embodiment, the air sleeve may be constructed as disclosed in U.S. Pat. Nos. 3,794,538 and 6,264,178, fully incorporated herein by reference.

In another embodiment, the invention is directed to a method of improving adhesion of a curable rubber composition to a reinforcement in an air sleeve or other article of manufacture comprising a composite material. The use of the chloroprene/dichlorobutadiene copolymer latex adhesive in the curable rubber composition as hereinbefore described results in a reinforcement layer with improved adhesion between the reinforcement and the vulcanizable rubber. While the improvement of adhesion is herein described with reference to an air sleeve, the invention is not so limited. Any application of a rubber compound wherein improved adhesion to a reinforcement comprising nylon and polychloroprene is desirable may come within the scope of the invention. Thus, it is envisioned to include other applications including automotive belts, tires, conveyor belts, automotive hoses, fuel transport hoses, etc.

The invention is further illustrated by the following non-limiting examples.

### EXAMPLE I

This example illustrates the effect of replacing the styrene-butadiene rubber of a standard RFL adhesive dip with polychloroprene in a nylon/polychloroprene composite. Polychloroprene/nylon composite Samples 1 through 4 were prepared from nylon cord dipped in various RFL adhesive dips as indicated in Table 1. The RFL dips were prepared by dissolving resorcinol in water, followed by addition of formaldehyde and sodium hydroxide. A 1:1 by solids mixture of a vinylpyridene/styrene/butadiene terpolymer latex and the styrene/butadiene latex or polychloroprene latex was then added, followed by dilution with water to give a final dip solids content of 14 percent by weight.

Nylon cord (DuPont, 1400 dtex/1/2, 10×10 tpi) was dipped and dried in a two-step dipping process in a Litzler Computreater 2000. The dipped cord was dried at 410° F. for 60 seconds, followed by curing at 450° F. for 60 seconds.

TABLE 1
RFL Dip Recipes (Component Amounts in Parts by Weight Solid)

| | Sample | | | |
|---|---|---|---|---|
| | 1 | 2 | 3 | 4 |
| SBR | 50 | 0 | 50 | 0 |
| Polychloroprene¹ | 0 | 50 | 0 | 50 |
| Blocked isocyanate² | 0 | 0 | 8 | 8 |
| Vinylpyride/styrene/butadiene terpolymer | 50 | 50 | 50 | 50 |

¹Neoprene 571, copolymer of chloroprene and sulfur
²Grilbond IL-6, caprolactam blocked methylene-bis-(4-penylisocyante)

Dipped cords were calendared into a standard Neoprene compound containing polychloroprene rubber and standard curatives including zinc oxide and sulfur, stearic acid, and antioxidants. The resulting composites were cured at two cure conditions, 15 minutes at 315° F. (low cure condition) and 7 minutes at 350° F. (high cure condition), and, tested at room temperature for static peel adhesion and hot dynamic flex adhesion. Results from these test are given in Table 2.

TABLE 2
Cord: DuPont Nylon, 1400 dtex/1/2, 10 × 10 tpi
Rubber: Standard Neoprene Compound

| | Test | | | |
|---|---|---|---|---|
| | 1 | 2 | 3 | 4 |
| Denier | 3120 | 3096 | 3138 | 3116 |
| Static Adhesion, N | | | | |
| (Test at Room Temp.) | | | | |
| 15 minutes at 310° F. | 250 (2*) | 252 (2) | 227 (1) | 240 (2) |
| 7 minutes at 350° F. | 217 (1) | 195 (1) | 208 (1) | 235 (2) |
| Dyn Flex, 15 minutes at 310° F., | | | | |
| ½″ speed, Room Temp. | | | | |
| 4 hours, Test at Room Temp. | | | | |
| Adhesion, N | | | | |
| Unflexed | 231 | 249 | 223 | 253 |
| Flexed | 166 | 208 | 166 | 230 |

*Rubber Coverage (0 to 5)

The data of Table 2 illustrate the effect of replacing SBR with polychloroprene in an RFL dip. For the lower temperature cure conditions, static adhesion and dynamic flex show equivalent or slightly improved values for polychloroprene dip (Sample 2) as compared to SBR dip (Sample 1). Addition of blocked isocyanate did not further improve the adhesion (Sample 4 vs. Sample 2). However, for the higher temperature cure conditions, static adhesion and dynamic flex showed significant improvement with a combined polychloroprene and blocked isocyanate dip (Sample 4 vs. Samples 1 and 2). This behavior was not observed for the combined SBR and blocked isocyanate dip (Sample 3 vs. Sample 1). It is believed that the higher temperature cure condition gives a closer simulation to performance of air sleeves.

### EXAMPLE II

This example illustrates the effect of replacing the styrene-butadiene rubber of a standard RFL adhesive dip with copolymer of chloroprene and dichlorobutadiene in a nylon/polychloroprene composite. Polychloroprene/nylon composite Samples 5 through 7 were prepared from nylon cord dipped in various RFL adhesive dips as indicated in Table 3. Other details of the processing and testing follow the procedures of Example 1.

TABLE 3
RFL Dip Recipes (Component Amounts in Parts by Weight Solid)

| | Sample | | |
|---|---|---|---|
| | 5 | 6 | 7 |
| SBR | 50 | 0 | 0 |
| Chloroprene/dichlorobutadiene copolymer¹ | 0 | 50 | 50 |
| Blocked isocyanate² | 0 | 0 | 8 |
| Vinylpyridene/styrene/butadiene terpolymer | 50 | 50 | 50 |

¹Neoprene 750, copolymer of chloroprene and 2,3-dichloro-1,3-butadiene
²Gilbond IL-6, caprolactam blocked methylene-bis-(4-phenylisocyanate)

Dipped cords were calendared into a standard Neoprene as indicated in Example I. The resulting composites were cured at two cure conditions, 15 minutes at 315° F. (low cure) and 7 minutes at 350° F. (high cure), and tested at room temperature for static peel adhesion and hot dynamic flex adhesion as shown in Table 4. Dipped cords were also evaluated using a pull out adhesion test which measures fiber to matrix bonding strength.

TABLE 4
Cord: DuPont Nylon, 1400 dtex/1/2, 10 × 10 tpi
Rubber: Standard Neoprene compound

| | Test | | |
|---|---|---|---|
| | 5 | 6 | 7 |
| Denier | 3123 | 3131 | 3146 |
| Static Adhesion, N | | | |
| 0(Test at Room Temp.) | | | |
| 15 minutes at 315° F. | 306 (0*) | 319 (4) | 306 (3) |
| 7 minutes at 350° F. | 265 (0) | 288 (4) | 285 (4.5) |
| Dyn Flex, 7 minutes at 350° F., | | | |
| ½″ speed, Room Temp. | | | |
| 4 hours, Test at Room Temp. | | | |
| Adhesion, N | | | |
| Unflexed | 246 | 281 | 275 |
| Flexed | 188 | 254 | 237 |
| Pull out adhesion, Energy to debond, J | 4.45 | 6.13 | — |
| DPU (%) | 7.3 | 6.8 | 6.3 |

*Rubber Coverage (0 to 5)

The data of Table 4 illustrate the effect of replacing SBR with a copolymer of chloroprene and dichlorobutadiene in an RFL dip. For both the lower and higher temperature cure conditions, static adhesion and dynamic flex show significant improved values for copolymer of chloroprene/dichlorobutadiene dip (Sample 6) as compared to SBR dip (Sample 5). Addition of blocked isocyanate did not further improve the adhesion for either the lower or higher temperature cures. (Sample 7 vs Sample 6). This is significant because for copolymer of chloroprene/dichlorobutadiene dip, the use of blocked isocyanate is not required to obtain and maintain good adhesion at higher temperature cure, as compared with the standard SBR dip. Apparently, the presence of the dichlorobutadiene in the copolymer acts to prevent the degradation of adhesion at high temperature cure that is observed with the polychloroprene dip that does not contain blocked isocyanate. It is believed that the higher temperature cure condition gives a closer simulation to performance of air sleeves.

While certain representative embodiments and details have been shown for the purpose of illustrating the subject invention, it will be apparent to those skilled in this art that various changes and modifications can be made therein without departing from the scope of the subject invention.

What is claimed is:

1. A composite material comprising a vulcanizable polychloroprene rubber composition and textile fibers, said fibers having distributed over surface portions thereof an adhesive comprising:
(A) a resorcinol-formaldehyde resin; and
(B) a copolymer of from about 1 weight percent to about 10 weight percent 2,3-dichloro-1,3-butadiene and from about 90 weight percent to about 99 weight percent chloroprene.

2. The composite material of claim 1, wherein said copolymer comprises from about 2 weight percent to about 5 weight percent 2,3-dichloro-1,3-butadiene and from about 95 weight percent to about 98 weight percent chloroprene.

3. The composite material of claim 1, wherein said adhesive further comprises a vinylpyridene-styrene-butadiene terpolymer.

4. The composite material of claim 3, where the weight ratio of copolymer of chloroprene and 2,3-dichloro-1,3-butadiene to vinylpyridene-styrene-butadiene terpolymer is from about 1 to about 2.

5. The composite material of claim 3, wherein the weight ratio of said copolymer of chloroprene and 2,3-dichloro-1,3-butadiene and vinylpyridene-styrene-butadiene terpolymer to said resorcinol-formaldehyde resin is from about 5 to about 7.

6. The composite material of claim 1, wherein said vulcanizable polychloroprene rubber composition further comprises at least one rubber is selected from the group consisting of poly-epichlorohydrin, polyisobutylene, halogenated-polyisobutylene, natural rubber, polyisoprene, polybutadiene, styrene-butadiene rubber, and mixtures thereof.

7. The composite material of claim 1, wherein textile fibers comprise a reinforcement selected from the group consisting of woven fabrics, knitted fabric, or spun bonded fabric, and fiber cord; and wherein said textile fibers comprise a material selected from the group consisting of rayon, nylon, polyester, aramid, cotton, and combinations thereof.

8. The composite material of claim 1, wherein said textile fibers comprises nylon.

9. The composite material of claim 1, wherein said adhesive further comprises a blocked isocyanate selected from the group consisting of caprolactam blocked methylene-bis-(4-phenylisocyanate) and phenol formaldehyde blocked isocyanates.

10. The composite material of claim 1, wherein said composite material is a component of an article of manufacture selected from the group consisting of air sleeves, automotive hoses, automotive belts, tires, conveyor belts, and automotive tracks.

11. A method of adhering a rubber compound to textile fibers in a composite material, comprising
(A) forming a vulcanizable rubber composition comprising polychloroprene rubber;
(B) distributing over surface portions of textile fibers an adhesive comprising a resorcinol-formaldehyde resin and a copolymer of from about 1 weight percent to about 10 weight percent 2,3-dichloro-1,3-butadiene and from about 90 weight percent to about 99 weight percent chloroprene;
(C) contacting said curable rubber composition with said textile fibers having said adhesive distributed over said surface portions thereof; and
(D) curing said curable rubber composition contacting said textile fibers having said adhesive distributed over said surface portions thereof.

12. The method of claim 11, wherein said copolymer comprises from about 2 weight percent to about 5 weight percent 2,3-dichloro-1,3-butadiene and from about 95 weight percent to about 98 weight percent chloroprene.

13. The method of claim 11, wherein said adhesive further comprises a vinylpyridene-styrene-butadiene terpolymer.

14. The method of claim 13, where the weight ratio of copolymer of chloroprene and 2,3-dichloro-1,3-butadiene to vinylpyridene-styrene-butadiene terpolymer is from about 1 to about 2.

15. The method of claim 13, wherein the weight ratio of said copolymer of chloroprene and 2,3-dichloro-1,3-butadiene and vinylpyridene-styrene-butadiene terpolymer to said resorcinol-formaldehyde resin is from about 5 to about 7.

16. The method of claim 11, wherein said vulcanizable polychloroprene rubber composition further comprises at least one rubber is selected from the group consisting of poly-epichlorohydrin, polyisobutylene, halogenated-polyisobutylene, natural rubber, polyisoprene, polybutadiene, styrene-butadiene rubber, and mixtures thereof.

17. The method of claim 11, wherein textile fibers comprise a reinforcement selected from the group consisting of woven fabrics, knitted fabric, or spun bonded fabric, and fiber cord; and wherein said textile fibers comprise a material selected from the group consisting of rayon, nylon, polyester, aramid, cotton, and combinations thereof.

18. The method of claim 11, wherein said textile fibers comprises nylon.

19. The method of claim 11, wherein said adhesive further comprises a blocked isocyanate selected from the group consisting of caprolactam blocked methylene-bis-(4-phenylisocyanate) and phenol formaldehyde blocked isocyanates.

20. The composite material of claim 1, wherein said composite material is a component of an article of manufacture selected from the group consisting of air sleeves, automotive hoses, automotive belts, tires, conveyor belts, and automotive tracks.
